(19) United States
(12) Patent Application Publication
(10) Pub. No.: US 2006/0033025 A1
(43) Pub. Date: Feb. 16, 2006

(54) Fluoride single-crystal material for thermoluminescence dosimeter, and thermoluminescence dosimeter

(75) Inventors: Noboru Ichinose, Yokohama-shi (JP); Kiyoshi Shimamura, Funabashi-shi (JP); Yuji Urano, Yokohama-shi (JP); Satoshi Nakakita, Yokohama-shi (JP)

Correspondence Address: HUNTLEY & ASSOCIATES, 1105 NORTH MARKET STREET, P.O. BOX 948, WILMINGTON, DE, 19899-0948, US

(73) Assignee: Hokushin Corporation

(21) Appl. No.: 11/232,267

(22) Filed: Sep. 21, 2005

(30) Foreign Application Priority Data
Mar. 24, 2003 (JP) 2003-80963

(51) Int. Cl. G01T 1/11

(52) U.S. Cl. 250/337; 250/484.3

(57) ABSTRACT

The present invention provides a fluoride single-crystal material for use in a thermoluminescence dosimeter, which material exhibits a thermoluminescence efficiency higher than that of conventional similar materials, and a thermoluminescence dosimeter employing the material.

The fluoride single-crystal material for use in a thermoluminescence dosimeter contains a compound represented by LiXAlF₆, wherein X is selected from the group consisting of Ca, Sr, Mg, and Ba, and, serving as a dopant, at least one species selected from among Ce, Na, Eu, Nd, Pr, Tm, Tb, and Er.

### TECHNICAL FIELD

The present invention relates to a fluoride single-crystal material for use in a thermoluminescence dosimeter which is employed for determining, for example, a personal radiation dose received by an occupationally exposed person working in a nuclear power plant or a similar facility; environmental radiation dose in a radiation-controlled zone; or radiation dose during exposure such as X-ray diagnosis. The invention also relates to a thermoluminescence dosimeter employing the single-crystal material.

### BACKGROUND ART

A thermoluminescence dosimeter element for use in a thermoluminescence dosimeter (in general, may be referred to simply as dosimeter) which is employed for determining, for example, a personal radiation dose received by an occupationally exposed person working in a nuclear power plant or a similar facility; environmental radiation dose in a radiation-controlled zone; or radiation dose during exposure such as X-ray diagnosis, employs a lithium borate phosphor (Li₂B₄O₇; abbreviated as LBO) (see, for example, Patent Documents 1 to 3), a lithium fluoride phosphor (LiF) (see, for example, Patent Document 4), or a similar material.

Among fluoride single-crystal materials, a lithium calcium aluminum single crystal (LiCaAlF₆; abbreviated as LiCAF) has been developed as material for optical parts (see, for example, Patent Documents 5 and 6). Incidentally, LiCAF has been reported to have characteristics suitable for a scintillator (see Non-Patent Documents 1 and 2). However, LICAF has a density as low as 2.94 g/cm³ and a small absorption coefficient with respect to γ rays, which is problematic.

As mentioned above, conventionally, thermoluminescence phosphors employed in thermoluminscence dosimeter elements exhibit unsatisfactory thermoluminescence efficiency and, therefore, thermoluminescence dosimeter elements exhibiting higher thermoluminescence efficiency are in keen demand.

<Patent Document 1>

Japanese Patent Publication (kokoku) No. 59-44332 (columns 1 and 2)

<Patent Document 2>

Japanese Patent Application Laid-Open (kokai) No. 7-35865 (Claims)

<Patent Document 3>

Japanese Patent Application Laid-Open (kokai) No. 2002-285150 (Claims and paragraphs 0001 to 0003)

<Patent Document 4>

Japanese Patent Application Laid-Open (kokai) No. 2000-206248 (Claims)

<Patent Document 5>

Japanese Patent Application Laid-Open (kokai) No. 2002-228801 (e.g., paragraphs 0001 to 0008)

<Patent Document 6>

Japanese Patent Application Laid-Open (kokai) No. 2002-234795 (e.g., paragraphs 0001 to 0006)

<Non-Patent Document 1>

“Scintillation decay of LiCaAlF₆:Ce³⁺ single crystals,” M. Nikl, N. Solovieva, E. Mihokova, M. Dusek, A. Vedda, M. Martini, K. Shimamura, and T. Fukuda, Phys. Stat. Sol. (a) 187 (2001) R1-R3.

<Non-Patent Document 2>

“LiCaAlF₆:Ce crystal: a new scintillator,” A. Gektin, N. Shiran, S. Neicheva, V. Gavrilyuk, A. Bensalah, T. Fukuda, and K. Shimamura, Nuclear Instruments and Methods in Physics Research A 486 (2002) 274-277.

### DISCLOSURE OF THE INVENTION

In view of the foregoing, an object of the present invention is to provide a fluoride single-crystal material for use in a thermoluminescence dosimeter, which material exhibits a thermoluminescence efficiency higher than that of conventional similar materials. Another object of the invention is to provide a thermoluminescence dosimeter employing the material.

The present inventors have found that a lithium calcium aluminum fluoride single crystal which is doped with a specific element or whose Ca is partially substituted by a specific element exhibits remarkably high thermoluminescence efficiency. The present invention has been accomplished on the basis of this finding.

Accordingly, a first mode of the present invention provides a fluoride single-crystal material for use in a thermoluminescence dosimeter, characterized in that the material comprises a compound represented by LiXAlF₆, wherein X is selected from the group consisting of Ca, Sr, Mg, and Ba, and, serving as a dopant, at least one species selected from among Ce, Na, Eu, Nd, Pr, Tm, Tb, and Er.

A second mode of the present invention is drawn to a specific embodiment of the material of the first mode, wherein X predominantly comprises Ca which is partially substituted by Sr, and is represented by CaₚSr_{q} (p+q=1, 0<q<1).

A third mode of the present invention is drawn to a specific embodiment of the material of the first mode, wherein X predominantly comprises Y which is substituted by Z, and is represented by YᵣZₛ (r+s=1, 0<s<0.2), Y being Ca or Sr, and Z being an element selected from the group consisting of Mg and Ba.

A fourth mode of the present invention provides a thermoluminescence dosimeter, characterized by comprising a thermoluminescence dosimeter element formed of a single-crystal material for use in a thermoluminescence dosimeter of any of the first to third modes, and a holder for holding the thermoluminescence dosimeter element.

As described hereinabove, the present invention provides a fluoride single-crystal material for use in a thermoluminescence dosimeter which material exhibits a thermoluminescence efficiency higher than that of conventional similar materials, and a thermoluminescence dosimeter employing the material.

### BRIEF DESCRIPTION OF THE DRAWINGS

FIG. 1 is a graph showing the results of thermoluminescence intensity measurement of the samples of Example 1 and Comparative Example performed in Test Example 1.

FIG. 2 is a graph showing the results of thermoluminescence intensity measurement of the samples of Example 2 and Comparative Example performed in Test Example 1.

FIG. 3 is a graph showing the results of thermoluminescence intensity measurement of the samples of Example 3 and Comparative Example performed in Test Example 1.

FIG. 4 is a graph showing the dependency of thermoluminescence intensity on radiation dose of the samples of Example 3 and Comparative Example investigated in Test Example 2.

### BEST MODES FOR CARRYING OUT THE INVENTION

The fluoride single-crystal material of the present invention for use in a thermoluminescence dosimeter comprises a compound represented by LiXAlF₆, wherein X is selected from the group consisting of Ca, Sr, Mg, and Ba. Preferably, X predominantly comprises calcium (Ca) or strontium (Sr).

When X predominantly comprises calcium, calcium may be partially substituted by strontium. In this case, X is represented by CaₚSr_{q} (p+q=1). The “q” may be selected from the range of “0<q<1.”

When X predominantly comprises Ca or Sr, Ca or Sr may be partially substituted by at least one of Mg and Ba. In this case, X is represented by YᵣZₛ (r+s=1), wherein Y represents Ca or Sr, and Z represents an element selected from the group consisting of Mg and Ba. The “s” may be selected from the range of “0<s<0.2.”

Preferably, the fluoride single-crystal material of the present invention for use in a thermoluminescence dosimeter contains at least one species selected from among Ce, Na, Eu, Nd, Pr, Tm, Tb, and Er, serving as a dopant. These elements are required for enhancing thermoluminescence efficiency.

Notably, when such a dopant is added to the fluoride, fluorescence intensity increases. However, such a dopant may cause variation in fluorescence intensity or lifetime. Thus, the dopant must be appropriately selected in accordance with desired characteristics.

The fluoride single-crystal material of the present invention for use in a thermoluminescence dosimeter is used in a thermoluminescence dosimeter element. Therefore, the fluoride must be produced in the form of high-quality, uniform bulk crystal. Such a bulk crystal is preferably formed through the following production method.

Specifically, the fluoride single-crystal material of the present invention for use in a thermoluminescence dosimeter is preferably produced through melt growth or solution growth. In the case of production of the rare earth metal fluoride of the present invention, melt growth or solution growth is preferably carried out under the following procedure. Polycrystalline fluoride sources in the form of powder or bulk are heated from room temperature to a temperature equal to or lower than the lowest melting point of the sources; e.g., 500 to 800° C., while a high vacuum of 10⁻⁴ to 10⁻⁵ Torr is maintained. After completion of feeding of argon and a freon gas such as CF₄ to a furnace (ratio by volume: freon gas:argon gas=100:0 to 0:100), the mixture is heated to a temperature equal to or higher than the highest melting point of the sources, thereby inducing reaction of an impurity generated or present in the melt or solution or on the surface of the melt or solution with the gas so as to remove the impurity. The single crystal is grown from the thus-produced melt or solution.

When the aforementioned production method is employed, high-quality single crystals can be produced in a simpler manner as compared with a conventional method, even when a fluoride source having a purity as low as 99.9 wt. % is used. The fluoride single crystal of the present invention can be produced from a melt or solution from which an impurity has been removed, in an inert gas (e.g., Ar) atmosphere, through melt growth or solution growth.

The fluoride single-crystal material of the present invention for use in a thermoluminescence dosimeter will next be described in more detail.

The fluoride single-crystal material of the present invention for use in a thermoluminescence dosimeter is produced through the following procedure. Specifically, a crucible is charged with polycrystalline or powdered matrix sources (e.g., lithium fluoride (LiF), calcium fluoride (CaF₂), and aluminum fluoride (AlF₃)), and, in accordance with needs, a dopant source (e.g., cerium fluoride (CeF₃)). The mixture is heated from room temperature to about 500 to 800° C. (i.e., a predetermined temperature not higher than the lowest melting point), while a high vacuum of about 10⁻⁴ to 10⁻⁵ Torr is maintained so as to remove water and oxygen contained in a furnace or the sources. Subsequently, argon and a freon gas such as CF₄ are fed to the furnace (ratio by volume:freon gas:argon gas=100:0 to 0:100), and the mixture is heated to a temperature equal to or higher than the highest melting point of the sources, thereby inducing reaction of an impurity generated or present in the melt or solution and on the surface of the melt or solution with the freon gas so as to remove the impurity. From the thus-produced melt or solution, a fluoride single crystal is produced.

No particular limitation is imposed on the method for producing a single crystal from the thus-produced melt or solution, and the pulling method or the Bridgman method may be employed. For example, when the pulling method is employed, the temperature of the melt is maintained in the vicinity of melting points of raw materials, and a seed crystal is pulled from the melt at 0.1 to 10 mm/h with rotation at 1 to 50 rpm, thereby producing a transparent, high-quality single crystal having no defects such as bubbles and scattering centers in the crystal.

The thus-produced fluoride single-crystal material for use in a thermoluminescence dosimeter is a useful material for a thermoluminescence dosimeter element.

Such a fluoride single crystal is cut to provide pieces of appropriate dimensions. A thermoluminescence dosimeter element employing such a single-crystal piece is sustained by a predetermined holder, thereby serving as a thermoluminescence dosimeter. The dosimeter absorbs radiations such as X-rays, γ-rays, and neutron beam, and the dose of the thus-accumulated radiations can be determined through measurement, by use of a reader, of the dose of thermoluminescence generated by heating.

### EXAMPLE 1

LiF, CaF₂, and AlF₃ (commercial bulk crushed materials, purity of 99.99%) were mixed at mole proportions of 1.01:1:1.01. To the mixture, CeF₃ and NaF serving as dopants were added each in an amount of 1 mol %. The resultant mixture was charged into a crucible, and the crucible was placed in a furnace for single crystal growth, and the interior pressure was reduced to about 10⁻⁴ to 10⁻⁵ Torr. Under the reduced pressure, the raw materials were heated to about 700° C. in order to remove water and oxygen contained in the furnace or the sources. Subsequently, CF₄ and argon (ratio by volume: 50:50) were fed to the furnace for single crystal growth, the raw materials were melted in the mixture gas atmosphere. The liquid state was maintained for three hours. Impurities migrated to the surface of the liquid were completely removed through reaction with CF₄ gas. Subsequently, a seed crystal was brought into contact with the melt, and pulled in the c-axis direction at a pulling rate of 1 mm/h with rotation of 15 rpm, thereby growing a single crystal. The thus-produced crystal was found to be a transparent, high-quality LiCaAlF₆:Ce,Na single crystal having dimensions (diameter: about 18.5 mm, length: about 80 mm) and no defects such as bubbles, cracks, and scattering centers.

### EXAMPLE 2

LiF, SrF₂, and AlF₃ (commercial bulk crushed materials, purity of 99.99%) were mixed at mole proportions of 1.01:1:1.01. To the mixture, CeF₃ and NaF serving as dopants were added each in an amount of 1 mol %. The resultant mixture was charged into a crucible, and the crucible was placed in a furnace for single crystal growth, and the interior pressure was reduced to about 10⁻⁴ to 10⁻⁵ Torr. Under the reduced pressure, the raw materials were heated to about 700° C. in order to remove water and oxygen contained in the furnace or the sources. Subsequently, CF₄ and argon (ratio by volume: 50:50) were fed to the furnace for single crystal growth, the raw materials were melted in the mixture gas atmosphere. The liquid state was maintained for three hours. Impurities migrated to the surface of the liquid were completely removed through reaction with CF₄ gas. Subsequently, a seed crystal was brought into contact with the melt, and pulled in the c-axis direction at a pulling rate of 1 mm/h with rotation of 15 rpm, thereby growing a single crystal. The thus-produced crystal was found to be a transparent, high-quality LiSrAlF₆:Ce,Na single crystal having dimensions (diameter: about 18.5 mm, length: about 80 mm) and no defects such as bubbles, cracks, and scattering centers.

### EXAMPLE 3

LiF, CaF₂, and AlF₃ (commercial bulk crushed materials, purity of 99.99%) were mixed at mole proportions of 1.01:1:1.01. To the mixture, EuF₃ serving as a dopant was added in an amount of 1 mol %. The resultant mixture was charged into a crucible, and the crucible was placed in a furnace for single crystal growth, and the interior pressure was reduced to about 10⁻⁴ to 10⁻⁵ Torr. Under the reduced pressure, the raw materials were heated to about 700° C. in order to remove water and oxygen contained in the furnace or the sources. Subsequently, CF₄ and argon (ratio by volume: 50:50) were fed to the furnace for single crystal growth, the raw materials were melted in the mixture gas atmosphere. The liquid state was maintained for three hours. Impurities migrated to the surface of the liquid were completely removed through reaction with CF₄ gas. Subsequently, a seed crystal was brought into contact with the melt, and pulled in the c-axis direction at a pulling rate of 1 mm/h with rotation of 15 rpm, thereby growing a single crystal. The thus-produced crystal was found to be a transparent, high-quality LiCaAlF₆:Eu single crystal having dimensions (diameter: about 18.5 mm, length: about 80 mm) and no defects such as bubbles, cracks, and scattering centers.

### EXAMPLE 4

LiF, SrF₂, and AlF₃ (commercial bulk crushed materials, purity of 99.99%) were mixed at mole proportions of 1.01:1:1.01. To the mixture, EuF₃ serving as a dopant was added in an amount of 1 mol %. The resultant mixture was charged into a crucible, and the crucible was placed in a furnace for single crystal growth, and the interior pressure was reduced to about 10⁻⁴ to 10⁻⁵ Torr. Under the reduced pressure, the raw materials were heated to about 700° C. in order to remove water and oxygen contained in the furnace or the sources. Subsequently, CF₄ and argon (ratio by volume: 50:50) were fed to the furnace for single crystal growth, the raw materials were melted in the mixture gas atmosphere. The liquid state was maintained for three hours. Impurities migrated to the surface of the liquid were completely removed through reaction with CF₄ gas. Subsequently, a seed crystal was brought into contact with the melt, and pulled in the c-axis direction at a pulling rate of 1 mm/h with rotation of 15 rpm, thereby growing a single crystal. The thus-produced crystal was found to be a transparent, high-quality LiSrAlF₆:Eu single crystal having dimensions (diameter: about 18.5 mm, length: about 80 mm) and no defects such as bubbles, cracks, and scattering centers.

### COMPARATIVE EXAMPLE

Through a conventionally known method, an Mg- and Ti-doped lithium fluoride single crystal (LiF:Mg,Ti) was produced.

### TEST EXAMPLE 1

Each of the single crystals produced in Examples 1 to 3 was irradiated at room temperature with X-rays at 1,000 R/min for three seconds and, subsequently, heated at a temperature elevation rate of 0.2° C./sec. Thermoluminescence (TLS) intensity was determined over the above temperature range.

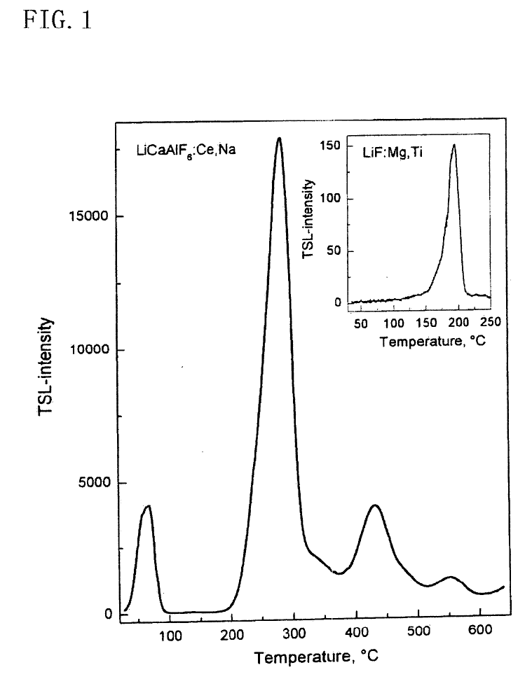

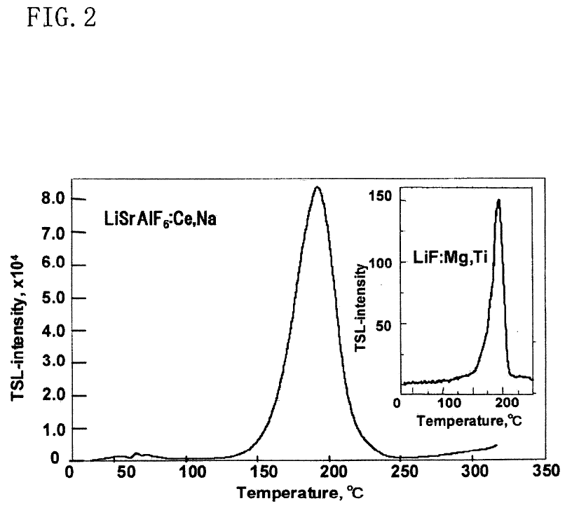

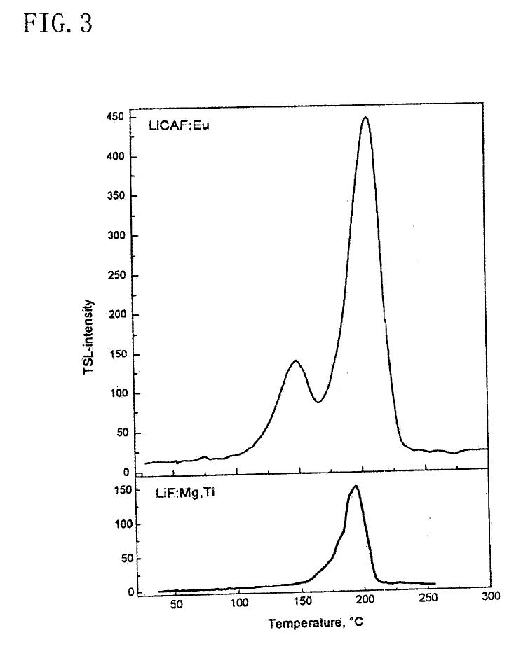

FIGS. 1 to 3 show the results. LiF:Mg,Ti, produced in Comparative Example, exhibits a TSL peak at 194° C. with a relative intensity of 150. In contrast, the LiCaAlF₆:Ce,Na single crystal, produced in Example 1, exhibits a TSL peak at 283° C. with a relative intensity of 17,884, which is 100 times or more the intensity attained by the crystal of Comparative Example. Similarly, the LiSrAlF₆:Ce single crystal, produced in Example 2, exhibits a TSL peak at 192° C. with a relative intensity of 84,500, and the LiCaAlF₆:Eu single crystal, produced in Example 3, exhibits a TSL peak at 206° C. with a relative intensity of 433. Thus, as compared with lithium fluoride of Comparative Example, single crystals produced in the Examples for use in a thermoluminescence dosimeter exhibit excellent TSL intensity.

### TEST EXAMPLE 2

The single crystals produced in Example 3 were irradiated at room temperature with X-rays at 0.1 to 1,000 mGy. After irradiation, each of the irradiated crystals was heated at a temperature elevation rate of 0.2° C./sec, and thermoluminescence (TLS) intensity was determined.

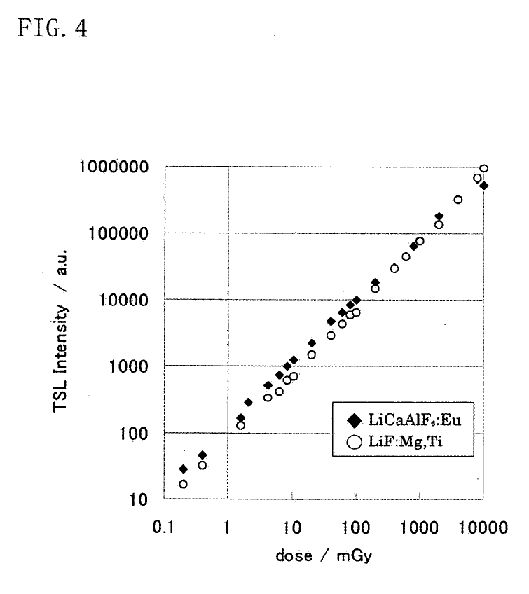

FIG. 4 shows the results. Currently, TLDs mainly employ LiF:Mg,Ti, from the viewpoint of more correct assessment of an effect of radiation on living bodies. When the above fluoride is used, the upper limit of measurement is lower than 10 Gy. The approximate line obtained through measurement of the LiF:Mg,Ti single crystal of Comparative Example and that obtained through measurement of the LiCaAlF₆:Eu single crystal of Example 3 were found to have almost the same slope, indicating that the two crystals closely correlate with each other. Thus, it is clear that, similar to LiF:Mg,Ti, which exhibits absorption characteristics equivalent to those of living bodies, LiCaAlF₆:Eu is remarkably suited for assessing radiation influences on living bodies. In addition, LiCaAlF₆:Eu exhibits linearity over a wide radiation dose range of 0.1 to 1,000 mGy, which linearity is equivalent to that of LiF:Mg,Ti, indicating that LiCaAlF₆:Eu can provide a dose measurement window almost equivalent to that of LiF:Mg,Ti.

### TEST EXAMPLE 3

Each of the single crystals produced in Examples 3 and 4 was irradiated at room temperature with a γ-ray at 0.8 Gy and, subsequently, heated at a temperature elevation rate of 17° C./sec. Thermoluminescence dose absorbed by each single crystal was determined. The results are shown in Table 1.

TABLE 1

| Single crystal | Relative thermoluminescence dose |
|---|---|
| LiF | 1 |
| LiCaAlF₆:Eu | 3.7 |
| LiSrAlF₆:Eu | 29.2 |

As is clear from Table 1, after the irradiation, LiCaAlF₆:Eu and LiSrAlF₆:Eu exhibited relative thermoluminescence dose values of 3.7 times and 29.2 times that of LiF.

1. A fluoride single-crystal material for use in a thermoluminescence dosimeter, characterized in that the material comprises a compound represented by LiXAlF₆, wherein X is selected from the group consisting of Ca, Sr, Mg, and Ba, and, serving as a dopant, at least one species selected from among Ce, Na, Eu, Nd, Pr, Tm, Tb, and Er.

2. A fluoride single-crystal material for use in a thermoluminescence dosimeter according to claim 1, wherein X predominantly comprises Ca which is partially substituted by Sr, and is represented by CaₚSr_{q} (p+q=1, 0<q<1).

3. A fluoride single-crystal material for use in a thermoluminescence dosimeter according to claim 1, wherein X predominantly comprises Y which is substituted by Z, and is represented by YᵣZₛ (r+s=1, 0<s<0.2), Y being Ca or Sr, and Z being an element selected from the group consisting of Mg and Ba.

4. A thermoluminescence dosimeter, characterized by comprising a thermoluminescence dosimeter element formed of a fluoride single-crystal material for use in a thermoluminescence dosimeter as recited in any of claims 1 to 3, and a holder for holding the thermoluminescence dosimeter element.
